(19) United States
(12) Patent Application Publication
(10) Pub. No.: US 2012/0081811 A1
(43) Pub. Date: Apr. 5, 2012

(54) DISK DRIVE AND METHOD OF WRITING TO DISK USING DISK DRIVE

(75) Inventors: Kyoung-whan Oh, Suwon-si (KR); Soo-il Choi, Yongin-si (KR); Woo-cheol Jeong, Seoul (KR)

(73) Assignee: SAMSUNG ELECTRONICS CO., LTD., Suwon-si (KR)

(21) Appl. No.: 13/240,642

(22) Filed: Sep. 22, 2011

(30) Foreign Application Priority Data
Oct. 5, 2010 (KR) 10-2010-0096917

(51) Int. Cl. G11B 5/09

(52) U.S. Cl. 360/69; G9B/5.033

(57) ABSTRACT

A method of writing to a disk using a disk drive includes determining a first sensing value using a first output value output from a disturbance sensor during a writing operation for multiple servo sectors on the disk, and determining a second sensing value using a second output value output from the disturbance sensor during the writing operation for the multiple servo sectors. Discontinuance of the writing operation is determined based on the difference between the first sensing value and the second sensing value.

### CROSS-REFERENCE TO RELATED APPLICATION

A claim of priority under 35 U.S.C. §119 is made to Korean Patent Application No. 10-2010-0096917, filed on Oct. 5, 2010, the entire contents of which are hereby incorporated by reference.

### BACKGROUND

The inventive concept relates to a disk drive, and more particularly, to a disk drive and a method of writing to a disk using a disk drive.

A disk drive rotates a disk using a spindle motor, and writes data to the disk or reads data from the disk using a head. Since a writing operation is performed on an adjacent track of the disk by a disturbance generated internally or externally while writing to the disk using the disk drive, data written to the adjacent track may be removed. A phenomenon in which data written to the adjacent track by a disturbance is removed may be referred to as rapid off-track erase (ROT).

### SUMMARY

The inventive concept provides method of writing to a disk using a disk drive based on a difference in output values of a disturbance sensor or a size of an output value of the disturbance sensor to account for disturbances. The inventive concept also provides a disk driver configured to use the method of writing to a disk.

According to an aspect of the inventive concept, there is provided a method of writing to a disk using a disk drive. The method includes determining a first sensing value using a first output value output from a disturbance sensor during a writing operation for multiple servo sectors on the disk, and determining a second sensing value using a second output value output from the disturbance sensor during the writing operation for the multiple servo sectors. Discontinuance of the writing operation is determined based on the difference between the first sensing value and the second sensing value.

The first sensing value may be determined at a first point of an nth (n is a natural number) servo sector of the sectors using the first output value, and the second sensing value may be determined at a second point of the nth servo sector using the second output value.

Determining the first sensing value may include beginning to convert the first output value into a digital first sensing value at a first time during a writing operation for an nth (n is a natural number) servo sector of the plurality of servo sectors; and obtaining the converted first sensing value at a second time during a writing operation for an n+1th servo sector of the servo sectors. Determining of the second sensing value may include beginning to convert the second output value into a digital second sensing value at a third time after the second time during the writing operation for the n+1th servo sector; and obtaining the converted second sensing value at a fourth time during the writing operation for the n+1th servo sector.

The fourth time may be a latest point in time in a section, where the writing operation for the n+1th servo sector is performed, and the third time may be a point in time occurring before the fourth time by an amount of time used to convert the second output value into the second sensing value.

A time interval between the first time and the second time, a time interval between the second time and the third time, and a time interval between the third time and the fourth time may be the same.

Determining the first sensing value may include beginning to convert the first output value into a digital first sensing value at a first time during a writing operation for an nth (n is a natural number) servo sector of the servo sectors; and obtaining the converted first sensing value at a second time during a writing operation for an n+1th servo sector of the plurality of servo sectors. Determining the second sensing value may include beginning to convert the second output value into a digital second sensing value at a third time after the second time during the writing operation for an n+1th servo sector; and obtaining the converted second sensing value at a fourth time during a writing operation for the n+2th servo sector of the servo sectors.

Determining the first sensing value may include beginning to convert the first output value into a digital first sensing value at a first time during a writing operation for an nth (n is a natural number) servo sector of the servo sectors; and obtaining the converted first sensing value at a second time after the first time during the writing operation for the nth servo sector. Determining the second sensing value may include beginning to convert the second output value into a digital second sensing value at a third time after the second time during the writing operation for the nth servo sector; and obtaining the converted second sensing value at a fourth time after the third time during the writing operation for the nth servo sector.

The disturbance sensor may be one of a rotary vibration (RV) sensor or a shock sensor. Also, determining the first sensing value and the second sensing value may be performed in a section in which one VCM interrupt service routine is performed.

Determining the discontinuance of the writing operation may include comparing an absolute value of the difference between the first sensing value and the second sensing value with a reference value. When the absolute value is above the reference value, the writing operation is discontinued. When the absolute value is below the reference value, the writing operation is continued.

According to another aspect of the inventive concept, there is provided a method of writing to a disk using a disk drive. The method includes determining a sensing value using an output value output by a rotary vibration (RV) sensor during writing operations for multiple servo sectors; and determining discontinuance of the writing operation by comparing a size of the determined sensing value with a reference value.

Determining the sensing value may include beginning to convert the output value into a digital sensing value at a first time during a writing operation for an nth (n is a natural number) servo sector of the servo sectors; and obtaining the converted sensing value at a second time during a writing operation for an n+1th servo sector of the servo sectors. Determining discontinuance of the writing operation may include comparing an absolute value of the sensing value with the reference value. When the absolute value is above the reference value, the writing operation is discontinued, and when the absolute value is below the reference value, the writing operation is continued.

According to another aspect of the inventive concept, there is provided a disk drive including a disturbance sensor and a controller. The disturbance sensor is configured to sense disturbances during a writing operation for a plurality of servo sectors on a disk. The controller is configured to determine a first sensing value using a first output value provided by the disturbance sensor during the writing operation, to determine a second sensing value using a second output value provided by the disturbance sensor during the writing operation, and to determine discontinuance of the writing operation based on the difference between the first sensing value and the second sensing value.

### BRIEF DESCRIPTION OF THE DRAWINGS

Illustrative embodiments of the inventive concept will be more clearly understood from the following detailed description taken in conjunction with the accompanying drawings, in which:

FIG. 1 is a block diagram of a data storage apparatus, according to an embodiment of the inventive concept;

FIG. 2 is a block diagram illustrating a software operating system of a hard disk drive (HDD) as the data storage apparatus of FIG. 1, according to an embodiment of the inventive concept;

FIG. 3 is a plan view of a head disk assembly of a disk drive as the data storage apparatus of FIG. 1, according to an embodiment of the inventive concept;

FIG. 4 is a block diagram illustrating an electric structure of the disk drive as the data storage apparatus of FIG. 1, according to an embodiment of the inventive concept;

FIG. 5A is a block diagram of a disk drive, according to an embodiment of the inventive concept;

FIG. 5B is a block diagram of a disk drive, according to another embodiment of the inventive concept;

FIGS. 6A through 6E depict illustrative servo sectors for illustrating an operation of the disk drive of FIG. 5A or the disk drive of FIG. 5B, according to embodiments of the inventive concept;

FIG. 7 is a flowchart illustrating a method of writing to a disk using the disk drive of FIG. 5A, according to an embodiment of the inventive concept;

FIG. 8 is a flowchart illustrating the method of FIG. 7, according to an embodiment of the inventive concept;

FIG. 9 is a flowchart illustrating the method of FIG. 7, according to another embodiment of the inventive concept;

FIG. 10 is a flowchart illustrating the method of FIG. 7, according to another embodiment of the inventive concept;

FIG. 11 is a flowchart illustrating a method of writing to a disk using the disk drive of FIG. 5B, according to an embodiment of the inventive concept;

FIG. 12 is a flowchart illustrating the method of FIG. 11, according to an embodiment of the inventive concept;

FIG. 13A is a graph illustrating differences according to the embodiments of FIGS. 5A, 7 through 10; and

FIG. 13B is a graph illustrating sensing values, according to the embodiments of FIGS. 5B, 11, and 12.

### DETAILED DESCRIPTION OF THE EMBODIMENTS

Embodiments of the inventive concept will be described in detail with reference to the accompanying drawings. The inventive concept, however, may be embodied in various different forms, and should not be construed as being limited only to the illustrated embodiments. Rather, these embodiments are provided as examples so that this disclosure will be thorough and complete, and will fully convey the concept of the inventive concept to those skilled in the art. Accordingly, known processes, elements, and techniques are not described with respect to some of the embodiments of the inventive concept. Unless otherwise noted, like reference numerals denote like elements throughout the attached drawings and written description, and thus descriptions will not be repeated.

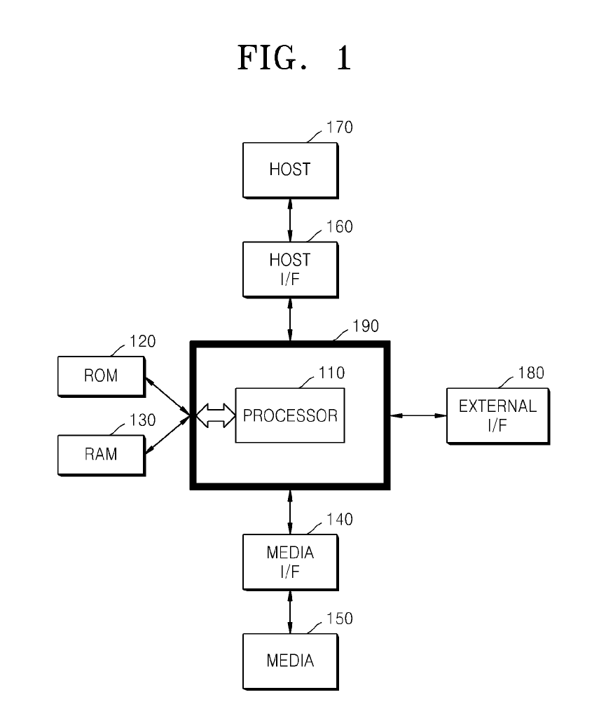

FIG. 1 is a block diagram of a data storage apparatus, according to an embodiment of the inventive concept.

Referring to FIG. 1, the data storage apparatus includes processor 110, read only memory (ROM) 120, random access memory (RAM) 130, media interface (I/F) 140, media 150, host I/F 160, host 170, external I/F 180, and bus 190.

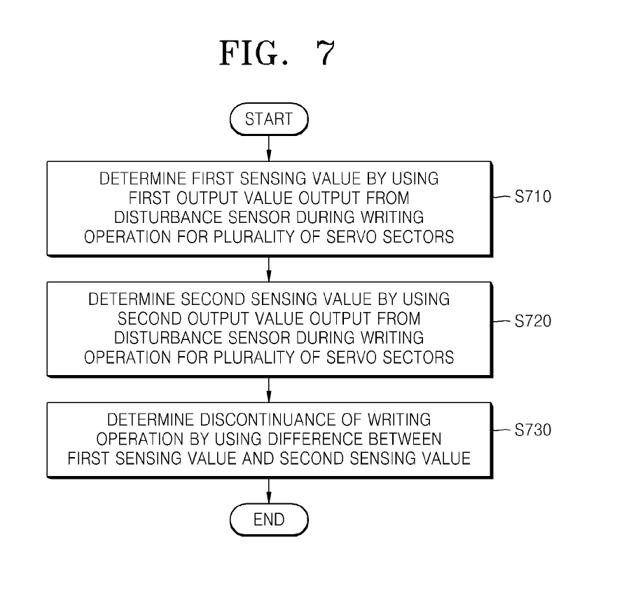

The processor 110 interprets commands and controls elements of the data storage apparatus according to results of interpretation. The processor 110 includes a code object management unit (not shown), and loads a code object stored in the media 150 to the RAM 130 using the code object management unit. The processor 110 may load code objects for executing a writing operation to a data storage apparatus, shown in FIGS. 7 through 10 to the RAM 130, for example.

The processor 110 performs a task for controlling a writing operation for the data storage apparatus, shown in FIGS. 7 through 10, using the code objects loaded to the RAM 130, and stores information required to execute the writing operation for the data storage apparatus in the media 150 or the ROM 120. Examples of the information required to execute the writing operation for the data storage apparatus may include standard values used to determine discontinuance of the writing operation by detection of a disturbance.

Methods of writing the data storage apparatus that may be executed by the processor 110 are described in detail with reference to FIGS. 7 through 10.

The ROM 120 or the media 150 stores program codes and data required to operate the data storage apparatus. The program codes and data stored in the ROM 120 or the media 150 are loaded to the RAM 130 under control of the processor 110.

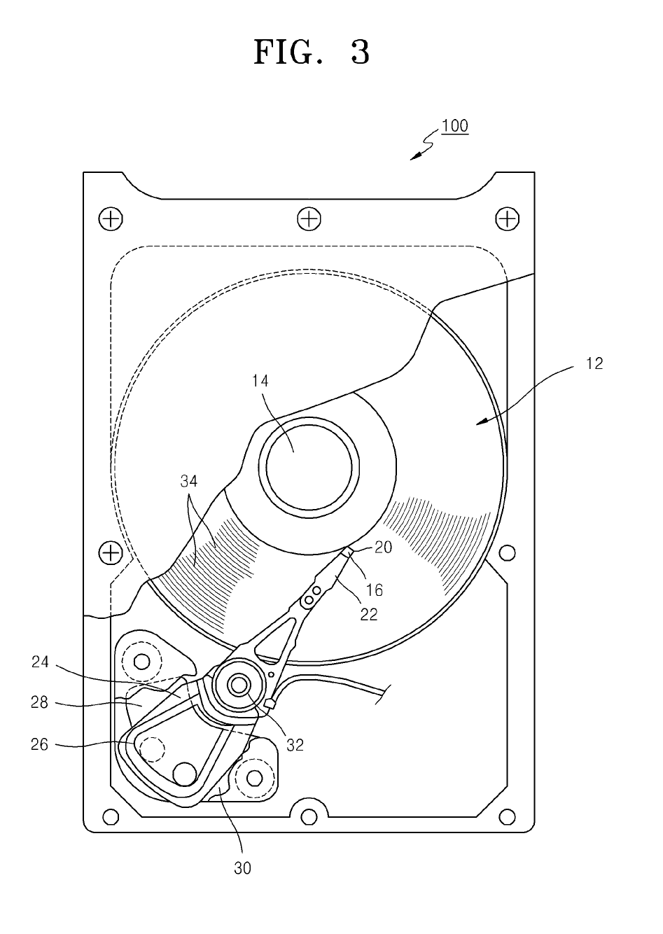

The media 150 is the main storage medium of the data storage apparatus and may include a disk, for example. The data storage apparatus may therefore include a disk drive, and a head disk assembly 100 included in the disk drive, including a disk and a head illustrated in the example depicted in FIG. 3

The media I/F 140 enables the processor 110 to access the media 150 in order to write and read information. The media I/F 140, which may be realized as a disk drive, in the data storage apparatus includes a servo circuit that controls the head disk assembly 100 and a read/write channel circuit that executes signal processing for data reading/writing.

The host I/F 160 communicates data with the host 170, which may be a personal computer, for example, and may include various standard interfaces such as a serial advanced technology attachment (SATA) interface, a parallel advanced technology attachment (PATA) interface, a universal serial bus (USB) interface, and the like.

The external I/F 180 communicates data with an external device (not shown) through an input/output terminal installed to the data storage apparatus, and may include various standard interfaces, such as an accelerated graphics port (AGP) interface, a USB interface, an IEEE1394 interface, a personal computer memory card international association (PCMCIA) interface, a LAN interface, a Bluetooth interface, a high definition multimedia interface (HDMI), a programmable communication interface (PCI), an industry standard architecture (ISA) interface, a peripheral component interconnect-express (PCI-E) interface, an express card interface, a SATA interface, a PATA interface, a serial interface, and the like.

The bus 190 communicates information among the various elements of the data storage apparatus.

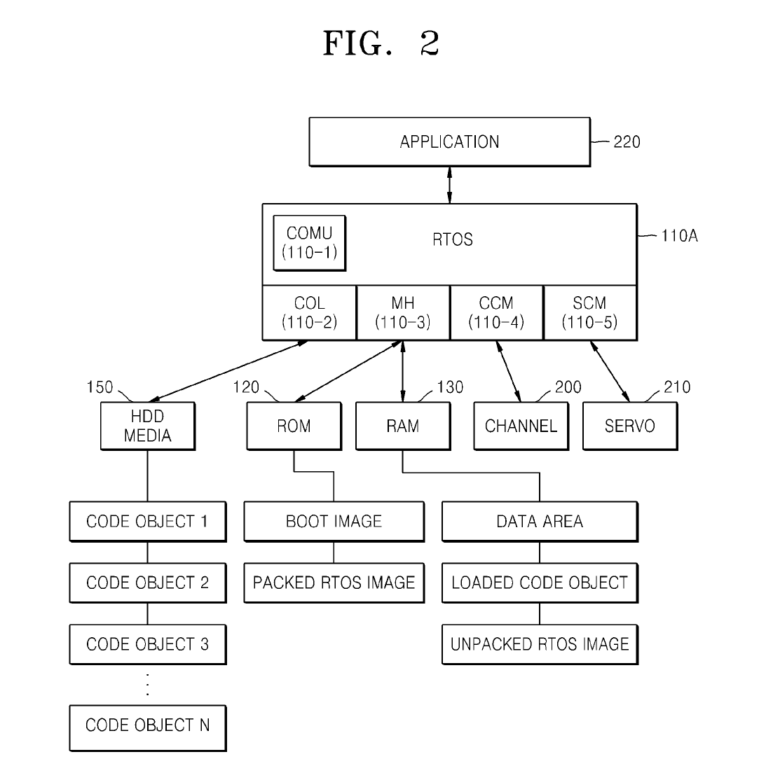

FIG. 2 is a block diagram illustrating a software operating system of a hard disk drive (HDD) as the data storage apparatus of FIG. 1, according to an embodiment of the inventive concept.

Referring to FIG. 2, multiple code objects 1 through N are stored in the media 150 of the HDD, which may be a disk, for example. The code objects 1-N stored in the disk may include code objects required to operate the disk drive, as well as code objects related to expanding various functions. More particularly, code objects for executing the methods of writing a disk drive, as shown in FIGS. 7 through 10, are stored in the disk. The code objects for executing the methods of FIGS. 7 through 10 may be stored in the ROM 120, instead of the media 150 of the HDD. In addition, code objects for executing various functions, such as an MP3 player function, a navigation function, and video games, may be stored in the disk

The ROM 120 stores a boot image and a packed real time operating system (RTOS) image. The RAM 130 reads the boot image from the ROM 120 while booting the disk drive, and an unpacked RTOS image is loaded to the RAM 130. Also, code objects required to operate a host I/F and external I/F (e.g., host I/F 160 and external I/F 180) stored in the media 150 of the HDD are loaded to the RAM 130. In the RAM 130, a data area for storing data is allocated.

A channel circuit 200 includes circuits required to process signals for reading/writing data. A servo circuit 210 includes circuits required to control the head disk assembly 100 to read/write data.

An RTOS 110A is a real time operating system program and is a multi-program operating system using a disk. In the RTOS 110A, real time multi-processing is performed as a foreground process having high priority, and batch processing is performed as a background process having low priority according to a task. Also, the RTOS 110A loads code objects from the disk and loads code objects onto the disk.

The RTOS 110A manages a code object management unit (COMU) 110-1, a code object loader (COL) 110-2, a memory handler (MH) 110-3, a channel control module (CCM) 110-4, and a servo control module (SCM) 110- to perform task according to requested commands. The RTOS 110A also manages application programs 220. For example, the RTOS 110A loads code objects required to control the disk drive while booting the disk drive to the RAM 130. Accordingly, the code objects loaded to the RAM 130 are used to operate the disk drive after the booting process.

The COMU 110-1 stores location information regarding locations to which code objects are written, converts virtual addresses into actual addresses, and arbitrates a bus. Also, the COMU 110-1 stores information regarding priorities of performed tasks. In addition, the COMU 110-1 manages task control block (TCB) information required to execute tasks for code objects, and stack information.

The COL 110-2 loads the code objects stored in the HDD media 150 to the RAM 130 using the COMU 110-1 and unloads the code objects stored in the RAM 130 to the HDD media 150. Accordingly, the COL 110-2 may load the code objects stored in the HDD media 150 used to execute the methods of FIGS. 7 through 10 to the RAM 130. The RTOS 110A may execute the methods of FIGS. 7 through 10 using the code objects loaded to the RAM 130.

The MH 110-3 writes or reads data to or from the ROM 120 and the RAM 130. The CCM 110-4 performs channel control required to process signals for reading/writing data, and the SCM 110-5 performs servo control operations for reading/writing data.

FIG. 3 is a plan view of the head disk assembly 100 of a disk drive as the data storage apparatus of FIG. 1, according to an embodiment of the inventive concept.

Referring to FIG. 3, the head disk assembly 100 includes at least one disk, indicated by representative disk 12, that rotates according to a spindle motor 14. The head disk assembly 100 also includes a head 16 disposed adjacent to a surface of the disk 12.

The head 16 may read information from or write information to the disk 12 by sensing magnetic fields of the disk 12 or by magnetizing the disk 12. In general, the head 16 corresponds to the disk 12. Although only one head 16 is illustrated, it is understood that the head 16 may separately include a head for writing used to magnetize each of multiple disks 12 and a head for reading used to sense the magnetic fields of the disks 12. The head for reading may be formed of a magneto-resistive (MR) element. The head 16 may be called a magnetic head or a transducer.

The head 16 may be integrated with a slider 20. The slider 20 generates an air bearing between the head 16 and the disk 12. The slider 20 is combined to a head gimbal assembly 22. The head gimbal assembly 22 is attached to an actuator arm 24 including a voice coil 26. The voice coil 26 is disposed adjacent to a magnetic assembly 28. A current supplied to the voice coil 26 generates a torque that rotates the actuator arm 24 against a bearing assembly 32. The actuator arm 24 rotates across the disk 12 so as to move the head 16.

Information is generally stored in annular tracks 34 of the disk 12. Each track 34 may generally includes multiple servo sectors. The servo sectors each include a servo area, to which servo information is stored, and multiple data sectors, to which data are stored.

A logic block address is allocated to a writable area of the disk 12. In the disk drive, the logic block address is converted into cylinder/head/sector information to designate a write area of the disk 12. The disk 12 is divided into a maintenance cylinder area, which is inaccessible to a user, and a user data area, which is accessible to the user. The maintenance cylinder area may be referred to as a system area. Various information required to control the disk drive is stored in the maintenance cylinder area, in addition to information required to detect a disturbance and to process compensation.

The head 16 moves across the surfaces of the disk 12 in order to read or write information in different tracks. Code objects used to realize various functions of the disk drive may be stored in the disk 12. For example, a code object for executing an MP3 player function, a code object for executing a navigation function, a code object for executing various video games, and the like, may be stored in the disk 12.

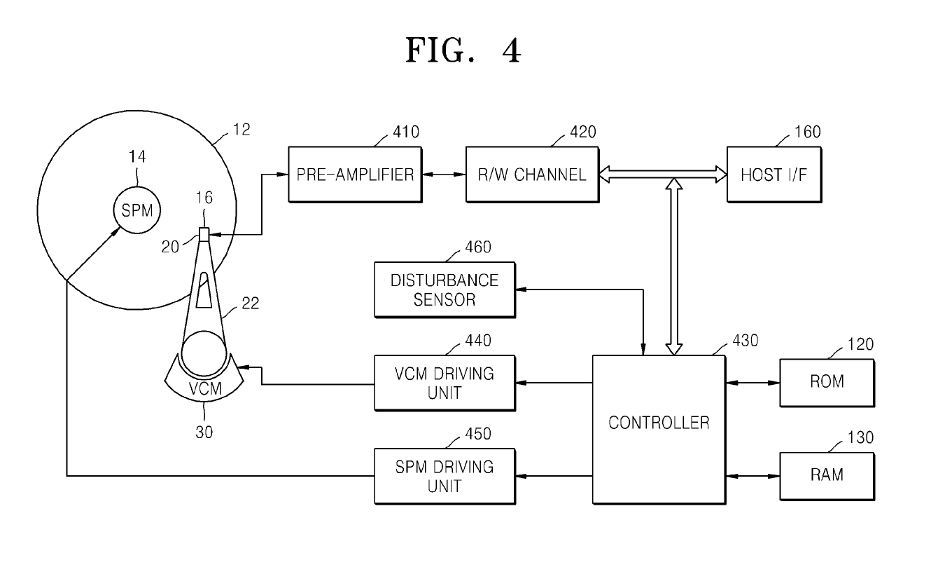

FIG. 4 is a block diagram illustrating an electric structure of the disk drive as the data storage apparatus of FIG. 1, according to an embodiment of the inventive concept.

Referring to FIG. 4, the disk drive includes a pre-amplifier 410, a read/write (R/W) channel 420, a controller 430, a VCM driving unit 440, a spindle motor (SPM) driving unit 450, and a disturbance sensor 460. The disk drive includes also includes the ROM 120, the RAM 130, and the host I/F 160.

The controller 430 may be a digital signal processor (DSP), a microprocessor, a microcontroller, or a processor, for example. The controller 430 controls the R/W channel 420 to read information from the disk 12 or to write information to the disk 12, according to a command received from a host through the host I/F 160.

The controller 430 is connected to the VCM driving unit 440, which supplies driving current to drive the VCM 30. The controller 430 provides a control signal to the VCM driving unit 440 in order to control movement of the head 16. The controller 430 is also connected to the SPM driving unit 450. The SPM driving unit 450 supplies driving current to drive the SPM 14. When power is supplied to the controller 430, the controller 430 provides a control signal to the SPM driving unit 450 in order to rotate the SPM 14 at a target speed.

The controller 430 is connected to the ROM 120 and the RAM 130. Firmware and control data used to control the disk drive are stored in the ROM 120. Also, program codes and information used to execute the methods of FIGS. 7 through 10, for example, may be stored in the ROM 120. In addition, program codes and information used to execute the methods of FIGS. 7 through 10, for example, may be stored in the maintenance cylinder area of the disk 12, instead of (or in addition to) the ROM 120. Also, the controller 430 may detect disturbances, according to the methods of FIGS. 7 through 10, using the program codes and information stored in the ROM 120 or the maintenance cylinder area of the disk 12, and may continue or stop a writing operation.

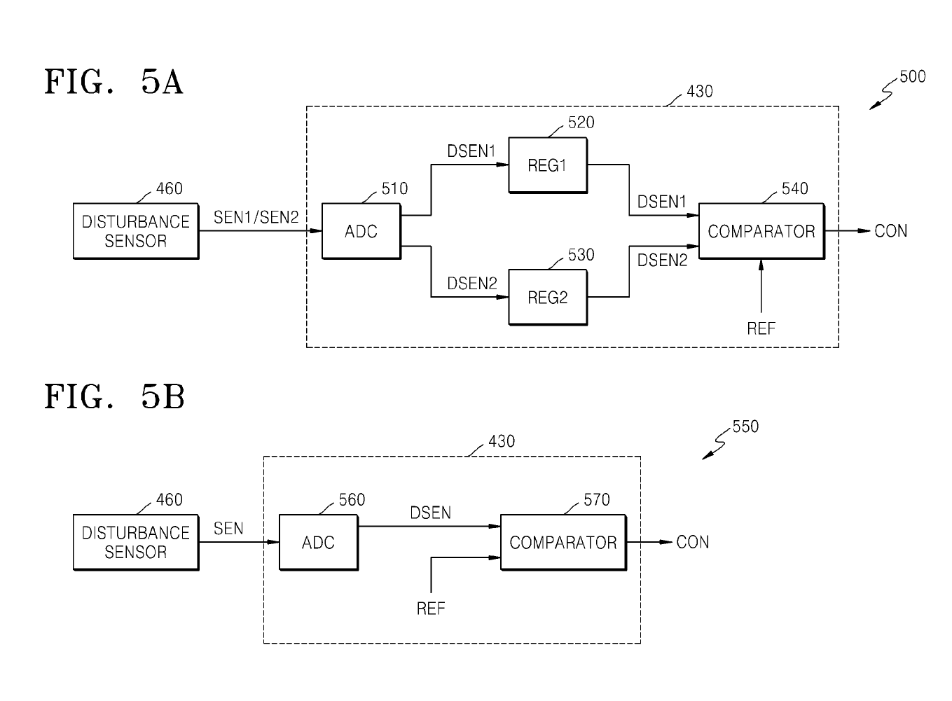

Also, the controller 430 is connected to the disturbance sensor 460. The disturbance sensor 460 senses disturbances generated from the disk drive or outside of the disk drive, and may be a rotary vibration (RV) sensor or a shock sensor, for example. When the disturbance sensor 460 is an RV sensor, the controller 430 may identify the degree of a disturbance (for example, rotary vibration) using an output value of the RV sensor to compensate for track following of the head. Also, when disturbance sensor 460 is a shock sensor, the controller 430 may identify the degree of a disturbance using an output value of the shock sensor to control discontinuance or continuance of a writing operation of the head. A method of controlling a writing operation by the controller 430 using output values of the disturbance sensor 460 are described more fully with reference to FIGS. 5 through 10.

General data reading and data writing operations in the disk drive are now described.

In a data read mode, the disk drive amplifies an electric signal sensed from the disk 12 through the head 16 in the pre-amplifier 410. Then, the signal output from the pre-amplifier 410 is amplified according to an automatic gain control circuit (not shown) that automatically varies gain based on intensity of a signal in the R/W channel 420. The amplified signal is converted into a digital signal, and then the digital signal is decoded, thereby detecting data. An error correction process may be performed on the detected data using a Reed-Solomon code as an error correction code, for example, in the controller 430. The data is converted into stream data, which is transmitted to the host through the host I/F 160.

In a data write mode, the disk drive receives data from the host through the host I/F 160, and provides an error correction symbol, such as a Reed-Solomon code, in the controller 430. The disk drive encodes the data into a form appropriate for a write channel in the R/W channel circuit 420, and writes the data to the disk 12 through the head 16 using a write current amplified in the pre-amplifier 410.

FIG. 5A is a block diagram of a disk drive 500, according to an embodiment of the inventive concept. In FIG. 5A, only the disturbance sensor 460 and the controller 430 are illustrated from among elements included in the disk drive of FIG. 4, for clarity of explanation.

Referring to FIG. 5A, the disturbance sensor 460 may be an RV sensor or a shock sensor, for example, and may sense a disturbance generated inside or outside of the disk drive, as described in relation to FIG. 4. The disturbance sensor 460 determines the degree of a disturbance during a writing operation for a predetermined servo sector and outputs an output value in analog form. That is, the disturbance sensor 460 may output a first output value SEN1 during a writing operation for an n^{th} (n is a natural number) servo sector from among a plurality of servo sectors and output a second output value SEN2 during a writing operation for an n+1^{th} servo sector from among the plurality of servo sectors. The n+1^{th} servo sector is disposed adjacent to the n^{th} servo sector and may be written to after the writing operation for the n^{th} servo sector is performed. Also, the disturbance sensor 460 may output the first and second output values SEN1 and SEN2 from one servo sector.

The controller 430 may control a writing operation of the head 16 using the first and second output values SEN1 and SEN2 of the disturbance sensor 460. That is, the controller 430 determines a first sensing value DSEN1 using the first output value SEN1, determines a second sensing value DSEN2 using the second output value SEN2, and determines a difference between the first and second sensing values DSEN1 and DSEN2. Thus, the controller 430 is able to determine discontinuance of the writing operation of the head 16 using the difference between the first and second sensing values DSEN1 and DSEN2. Also, the controller 430 is able to determine discontinuance of the writing operation of the head 16 using the difference between the first and second sensing values DSEN1 and DSEN2 determined using the first and second output values SEN1 and SEN2 of the disturbance sensor 460 output from one servo sector from among the plurality of servo sectors.

The controller 430, according to the depicted embodiment of the inventive concept, may include an analog-to-digital converter (ADC) 510, a first register 520, a second register 530, and a comparator 540. However, the inventive concept is not limited to this configuration, and thus the controller 430 may include other elements to operate as described herein, without departing from the spirit of the present teachings.

The ADC 510 converts the first output value SEN1 into the first (digital) sensing value DSEN1 and converts the second output value SEN2 into the second (digital) sensing value DSEN2. For example, the ADC 510 may output the first sensing value DSEN1 obtained by converting the first output value SEN1, the first sensing value DSEN1 being stored in the first register 520 before the second output value SEN2 is input during the writing operation for the n+1^{th} servo sector. Also, the ADC 510 may output the second sensing value DSEN2 obtained by converting the second output value SEN2, the second sensing value DSEN2 being stored in the second register 530 before the first output value SEN1 of the disturbance sensor 460 is input during the writing operation for the n+1^{th} servo sector. In addition, the ADC 510 may output the second sensing value DSEN2 obtained by converting the second output value SEN2, the second sensing value DSEN2 being stored in the second register 530 during a writing operation for an n+2^{th} servo sector from among the plurality of servo sectors. The n+2^{th} servo sector is disposed adjacent to the n+1^{th} servo sector and may be written to after the writing operation for the n+1^{th} servo sector is performed.

When the first and second output values SEN1 and SEN2 output from one servo sector (for example, the n^{th} servo sector) by the disturbance sensor 460 are used, the ADC 510 may output the first sensing value DSEN1 obtained by converting the first output value SEN1 and stored in the first register 520 before the second output value SEN2 is input during the writing operation for the n^{th} servo sector, and may output the second sensing value DSEN2 obtained by converting the second output value SEN2 and stored in the second register 530 before the writing operation for the n^{th} servo sector is completed.

The comparator 540 compares a difference between the first sensing value DSEN1 stored in the first register 520 and the second sensing value DSEN2 stored in the second register 530 with a predetermined reference value REF. The comparison may be used to determine discontinuance of the writing operation of the head 16. For example, when an absolute value of the difference is greater than (or equal to) the reference value REF, the comparator 540 may generate a control signal CON that discontinues the writing operation of the head 16. When an absolute value of the difference is less than the reference value REF, the comparator 540 may generate a control signal CON that continues the writing operation of the head 16. That is, when the absolute value of the difference between the first sensing value DSEN1 and the second sensing value DSEN2 is greater than the reference value REF, the controller 430 determines that a writing operation may be performed on an adjacent track and thus discontinues the writing operation. Then, the controller 430 may control the writing operation to be performed again from a servo sector before the n+1^{th} servo sector by a predetermined number. For example, the control signal CON may be a signal that enables or disables the RW channel 420 and/or the pre-amplifier 410 shown in FIG. 4.

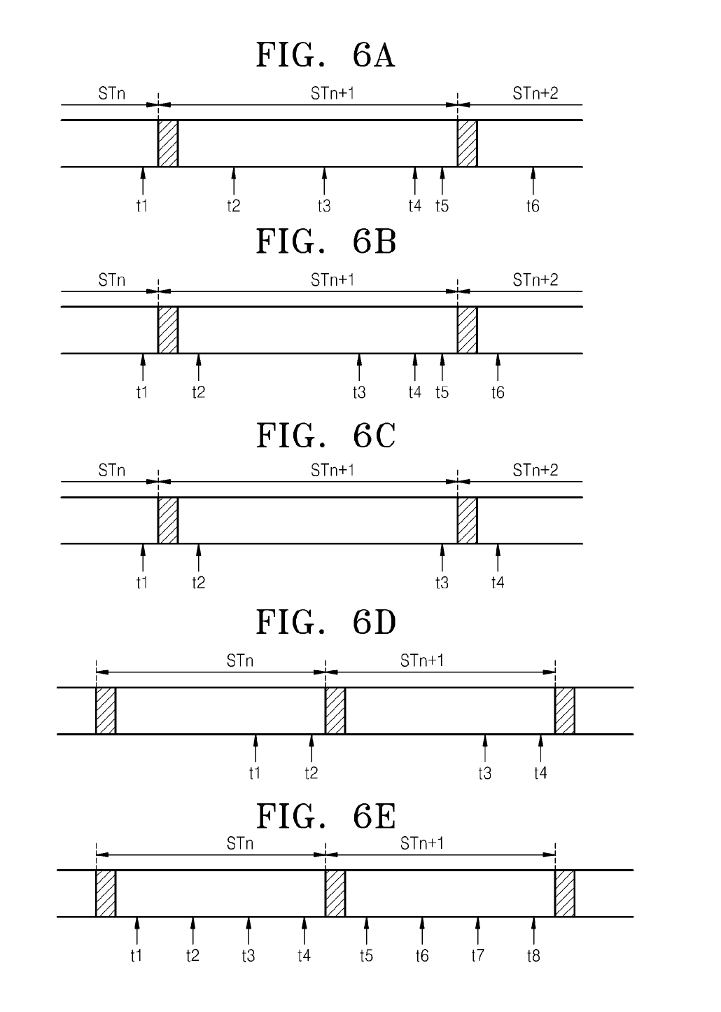

Operations of the disturbance sensor 460 and the controller 430 of FIG. 5A are described more fully with reference to FIGS. 6A through 6E.

FIG. 5B is a block diagram of a disk drive 550, according to another embodiment of the inventive concept. In FIG. 5B, only the disturbance sensor 460 and the controller 430 are illustrated from among elements included in the disk drive of FIG. 4, for clarity of explanation.

Referring to FIG. 5B, the disturbance sensor 460 senses a disturbance generated inside or outside of the disk drive, as described in relation to FIG. 4, and may be an RV sensor or a shock sensor, for example. The disturbance sensor 460 determines the degree of a disturbance during a writing operation for a predetermined servo sector, and outputs an output value in analog form. That is, the disturbance sensor 460 may output one output value SEN from one servo sector.

The controller 430 may control a writing operation of the head 16 using the output value SEN of the disturbance sensor 460. That is, the controller 430 may determine discontinuance of the writing operation based on a sensing value DSEN determined using the output value SEN output from the disturbance sensor 460.

The controller 430 according to the current embodiment of the inventive concept may include an ADC 560 and a comparator 570. However, the inventive concept is not limited to this configuration, and thus the controller 430 may include other elements to operate as described herein, without departing from the scope of the present teachings.

The ADC 560 converts the output value SEN into a (digital) sensing value DSEN, and outputs the sensing value DSEN to the comparator 570. For example, the ADC 560 may convert the output value SEN output by the disturbance sensor 460 from an n^{th} servo sector into the sensing value DSEN, and output the sensing value DSEN during the writing operation for the n^{th} servo sector or an n+1^{th} servo sector that is adjacent to the n^{th} servo sector.

The comparator 570 compares the sensing value DSEN output from the ADC 560 with a predetermined reference value REF, and may determine discontinuance of the writing operation of the head 16 based on the comparison. For example, when an absolute value of the sensing value DSEN is greater than the reference value REF, the comparator 570 may generate a control signal CON that discontinues the writing operation of the head 16. When an absolute value of the sensing value DSEN is less than the reference value REF, the comparator 570 may generate a control signal CON that continues the writing operation of the head 16. That is, when the absolute value of the sensing value DSEN is greater than (or equal to) the reference value REF, the controller 430 determines that a writing operation may be performed on an adjacent track and thus discontinues the writing operation. Then, the controller 430 may control performance of the writing operation again from a servo sector disposed before the n^{th} servo sector by a predetermined number. For example, the control signal CON may be a signal that enables or disables the RW channel 420 and/or the pre-amplifier 410 of FIG. 4.

Operations of the disturbance sensor 460 and the controller 430 of FIG. 5B are described more fully with reference to FIGS. 6C through 6D.

FIGS. 6A through 6E depict illustrative servo sectors STn, STn+1, and STn+2 for illustrating an operation of the disk drive 500 of FIG. 5A or the disk drive 550 of FIG. 5B, according to embodiments of the inventive concept.

Referring to FIGS. 6A through 6E, portions of the servo sectors STn, STn+1, and STn+2 indicated by oblique lines are servo areas, to which servo information is stored, and portions between the servo areas are data areas, to which data are stored. Multiple data sectors may be disposed in the data areas. A preamble, a servo synchronization display signal, gray codes, burst signals, and the like, may be recorded to the servo areas. The preamble provides clock synchronization while reading servo information, and includes a gap before the servo area so as to provide a regular timing margin. Also, the preamble is used to determine a gain of an automatic gain control (AGC) circuit. The servo synchronization display signal may include a servo address mark and a servo index mark. The servo address mark is a signal indicating a start of a servo sector, and the servo index mark is a signal indicating a start of a first servo sector in a track. The gray code provides track information, and the burst signal is used to control the head 16 to follow the center of the track 34. For example, the burst signal may include four patterns A, B, C, and D and four burst patterns are combined to generate position error signal PES used to control track following.

Hereinafter, operation of the disk drive 500 is described with reference to FIGS. 5A and 6A. First, an example in which the disturbance sensor 460 included in the disk driver 500 is an RV sensor is described.

When the disturbance sensor 460 is an RV sensor, it senses a disturbance at first time t1 during a writing operation for an n^{th} servo sector STn, and outputs the first output value SEN1. The ADC 510 may begin to convert the first output value SEN1 into the digital first sensing value DSEN1 at the first time t1. For convenience of description, the time between when the disturbance sensor 460 begins to output the first output value SEN1 and when the ADC 510 begins to convert the first output value SEN1 into the first sending value DSEN1 is ignored. The digital first sensing value DSEN1 is obtained upon completion of converting the first output value SEN1 by the ADC 510, and may be stored in the first register 520 as the first sensing value DSEN1, at second time t2, where a writing operation for a first point of the n+1^{th} servo sector STn+1 is performed. That is, the time between the first time t1 and the second time t2 may be greater than the time used converting the first output value SEN1 in analog form into the first sensing value DSEN1 in digital form by the ADC 510.

The disturbance sensor 460 senses a disturbance at third time t3 during a writing operation for the n+1^{th} servo sector STn+1, and outputs the second output value SEN2. The ADC 510 may begin to convert the second output value SEN2 into the digital second sending value DSEN2 at the third time t3. For convenience of description, the time between when the disturbance sensor 460 begins to output the second output value SEN2 and when the ADC 510 begins to convert the second output value SEN2 into the second sensing value DSEN2 is ignored. The digital second sensing value DSEN2 is obtained upon completion of converting the second output value SEN2 by the ADC 510, and may be stored in the second register 530 as the second sensing value DSEN2, at fourth time t4, where a writing operation for a second point of the n+1^{th} servo sector STn+1 is performed. That is, the time between the third time t3 and the fourth time t4 may be greater than the amount of time used to convert the second output value SEN2 in analog form into the second sensing value DSEN2 in digital form by the ADC 510.

The comparator 540 compares the reference value REF with the difference between the first sensing value DSEN1 and the second sensing value DSEN2 at a predetermined time after the fourth time t4, and generates the control signal CON for determining discontinuance of the writing operation. For example, when an absolute value of the difference between the first sensing value DSEN1 and the second sensing value DSEN2 is compared with the reference value REF and the absolute value exceeds the reference value REF, the comparator 540 may generate the control signal CON for discontinuing the writing operation. When the absolute value is less than the reference value REF, the comparator 540 may generate the control signal CON for continuing the writing operation.

The disturbance sensor 460 senses a disturbance at fifth time during a writing operation for the n+1^{th} servo sector STn+1, and outputs the first output value SEN1. The ADC 510 may start to convert the first output value SEN1 into the digital first sensing value DSEN1 at the fifth time t5. The digital first sensing value DSEN1 is obtained upon completion of converting the first output value SEN1 by the ADC 510, and may be stored in the first register 520 as the first sensing value DSEN1, at sixth time t6, where a writing operation for a first point of the n+2^{th} servo sector STn+2 is performed. The operation performed at the fifth time t5 is the same as the operation performed at the first time t1, and the operation performed at the sixth time t6 is the same as the operation performed in the second time t2. Thus, detailed descriptions thereof will not be repeated. That is, the operations described in relation to the first time t1 through the fourth time t4 may be performed for remaining servo sectors.

In FIG. 6A, a time interval between the first time t1 and the second time t2, a time interval between the second time t2 and the third time t3, and a time interval between the third time t3 and the fourth time t4 are the same as each other. The fourth time t4 may be the latest point in time in a section where the writing operation for the n+1^{th} servo sector STn+1 is performed. For example, when the fourth time t4 is the latest point in time in the section where the writing operation for the n+1^{th} servo sector STn+1 is performed, the third time t3 may be a point in time before the fourth time t4 by the amount of time used to convert the second output value SEN2 in analog form into the second sensing value DSEN2 in digital form in the ADC 510. Also, the first time t1 may be the latest point in time in a section where the writing operation for the n^{th} servo sector STn is performed and the second time t2 may be the point in time before the third time t3. Also, the disturbance sensor 460 and the controller 430 described above may be operated in a section where one VCM interrupt service routine is performed.

The case in which the disturbance sensor 460 is the RV sensor is described above in relation to FIGS. 5A and 6A. However, when the disturbance sensor 460 is the shock sensor, the difference between the first sensing value DSEN1 and the second sensing value DSEN2 may be used to determine discontinuance of the writing operation, as described above. Thus, the problem of rapid off-track erase (ROT) may be efficiently addressed. In various embodiments of the inventive concept, the disturbance sensor 460 is not limited to the RV sensor or the shock sensor. When the disturbance sensor 460 is another sensor that may sense a disturbance, discontinuance of the writing operation may be determined.

Hereinafter, operation of the disk drive 500 is described with reference to FIGS. 5A and 6B. First, an example in which the disturbance sensor 460 included in the disk driver 500 is an RV sensor is described.

When the disturbance sensor 460 is an RV sensor, it senses a disturbance at a first time t1 during a writing operation for an n^{th} servo sector STn and outputs the first output value SEN1. The ADC 510 may start to convert the first output value SEN1 into the digital first sensing value DSEN1 at the first time t1. For convenience of description, the time between when the disturbance sensor 460 begins to output the first output value SEN1 and when the ADC 510 begins to convert the first output value SEN1 into the first sensing value DSEN1 is ignored. The digital first sensing value DSEN1 is obtained upon completion of converting the first output value SEN1 by the ADC 510, and may be stored in the first register 520 as the first sensing value DSEN1, at second time t2 during a writing operation for the n+1^{th} servo sector STn+1. That is, the time between the first time t1 and the second time t2 may be greater than the amount of time used to convert the first output value SEN1 in analog form into the first sensing value DSEN1 in digital form in the ADC 510.

The disturbance sensor 460 senses a disturbance at third time t3 during a writing operation for the n+1^{th} servo sector STn+1, and outputs the second output value SEN2. The ADC 510 may start to convert the second output value SEN2 into the digital second sensing value DSEN2 at the third time t3. For convenience of description, the time between when the disturbance sensor 460 begins to output the second output value SEN2 and the time when the ADC 510 begins to convert the second output value SEN2 into the second sensing value DSEN2 is ignored. The digital second sensing value DSEN2 is obtained upon completion of converting the second output value SEN2 by the ADC 510, and may be stored in the second register 530 as the second sensing value DSEN2, at fourth time t4 during a writing operation for the n+1^{th} servo sector STn+1. That is, the time between the third time t3 and the fourth time t4 may be greater than the amount of time used to convert the second output value SEN2 in analog form into the second sensing value DSEN2 in digital form in the ADC 510.

The comparator 540 compares the difference between the first sensing value DSEN1 and the second sensing value DSEN2 with the reference value REF at a predetermined time point after the fourth time t4 and may generate the control signal CON for determining discontinuance of the writing operation.

The disturbance sensor 460 senses a disturbance at fifth time t5 during a writing operation for the n+1^{th} servo sector STn+1, and outputs the first output value SEN1. The ADC 510 may begin to convert the first output value SEN1 into the digital first sensing value DSEN1 at the fifth time t5. The digital first sensing value DSEN1 is obtained upon completion of converting the first output value SEN1 by the ADC 510, and may be stored in the first register 520 as the first sensing value DSEN1, at sixth time t6 during a writing operation for the n+2^{th} servo sector STn+2. The operation performed at the fifth time t5 is the same as the operation performed at the first time t1, and the operation performed at the sixth time t6 is the same as the operation performed in the second time t2. Thus, detailed descriptions thereof will not be repeated. That is, the operations described in relation to the first time t1 through the fourth time t4 may be performed for remaining servo sectors.

In FIG. 6B, the third time t3 may be the latest point in time in a section where the writing operation for the n+1^{th} servo sector STn+1 is performed. For example, when the fourth time t4 is the latest time in the section where the writing operation for the n+1^{th} servo sector STn+1 is performed, the third time t3 may be a point in time before the fourth time t4 by the time consumed to convert the second output value SEN2 in analog form into the second sensing value DSEN2 in digital form in the ADC 510. Also, the first time t1 may be the latest point in time in a section where the writing operation for the n^{th} servo sector STn is performed and the second time t2 may be the point in time before the third time t3. That is, in FIG. 6B, at least one of the first time t1 and the third time t3 is the latest point in time. Also, the disturbance sensor 460 and the controller 430 described above may be operated in a section where one VCM interrupt service routine is performed.

The case in which the disturbance sensor 460 is the RV sensor is described above in relation to FIGS. 5A and 6B. However, when the disturbance sensor 460 is the shock sensor, the difference between the first sensing value DSEN1 and the second sensing value DSEN2 may be used to determine discontinuance of the writing operation, as described above. Thus, the problem of ROT may be efficiently addressed. In embodiments of the inventive concept, the disturbance sensor 460 is not limited to the RV sensor or the shock sensor. When the disturbance sensor 460 is another sensor that may sense a disturbance, discontinuance of the writing operation may be determined.

Hereinafter, operation of the disk drive 500 is described with reference to FIGS. 5A and 6C. First, an example in which the disturbance sensor 460 included in the disk driver 500 is an RV sensor, is described.

When the disturbance sensor 460 is an RV sensor, it senses a disturbance at first time t1 during a writing operation for an n^{th} servo sector STn, and outputs the first output value SEN1. The ADC 510 may begin to convert the first output value SEN1 into the first digital value DSEN1 at the first time t1. For convenience of description, time between when the disturbance sensor 460 begins to output the first output value SEN1 and when the ADC 510 begins to convert the first output value SEN1 into the first digital value DSEN1 is ignored. The digital first sensing value DSEN1 is obtained upon completion of converting the first output value SEN1 by the ADC 510, and may be stored in the first register 520 as the first sensing value DSEN1, at second time t2 during a writing operation for the n+1^{th} servo sector STn+1. That is, the time between the first time t1 and the second time t2 may be greater than the amount of time used to convert the first output value SEN1 in analog form into the first sensing value DSEN1 in digital form in the ADC 510.

The disturbance sensor 460 senses a disturbance at third time t3 during a writing operation for the n+1^{th} servo sector STn+1, and outputs the second output value SEN2. The ADC 510 may begin to convert the second output value SEN2 into the digital second sensing value DSEN2 at the third time t3. For convenience of description, time between when the disturbance sensor 460 begins to output the second output value SEN2 and when the ADC 510 begins to convert the second output value SEN2 into the second digital value DSEN2 is ignored. The digital second sensing value DSEN2 is obtained upon completion of converting the second output value SEN2 by the ADC 510, and may be stored in the second register 530 as the second sensing value DSEN2, at fourth time t4 during a writing operation for the n+2^{th} servo sector STn+2. That is, the time between the third time t3 and the fourth time t4 may be greater than time consumed to convert the second output value SEN2 in analog form into the second sensing value DSEN2 in digital form in the ADC 510.

The comparator 540 compares the difference between the first sensing value DSEN1 and the second sensing value DSEN2 with the reference value REF at a predetermined point in time after the fourth time t4, and generates the control signal CON for determining discontinuance of the writing operation, in accordance with the comparison.

The operations described in relation to the first time t1 through the fourth time t4 may be performed for remaining servo sectors. In FIG. 6C, the first time t1 may be the latest point in time in a section where the writing operation for the n^{th} servo sector STn is performed, and the third time t3 may be the latest point in time in a section where the writing operation for the n+1^{th} servo sector STn+1 is performed. That is, the disturbance sensor 460 in FIG. 6C is operated as in the same manner as in a general RV sensor; however, discontinuance of the writing operation is determined by comparing the difference between the output values of the disturbance sensor 460 with the reference value REF. Thus, the problem of ROT may be efficiently addressed. Also, in FIG. 6C, a time interval between the first time t1 and the second time t2, a time interval between the second time t2 and the third time t3, and a time interval between the third time t3 and the fourth time t4 may be the same as each other or different from each other. In addition, the disturbance sensor 460 and the controller 430 described above may be operated in a section where one VCM interrupt service routine is performed.

The case in which the disturbance sensor 460 is the RV sensor is described above in relation to FIGS. 5A and 6C. However, when the disturbance sensor 460 is the shock sensor, the difference between the first sensing value DSEN1 and the second sensing value DSEN2 may be used to determine discontinuance of the writing operation, as described above. Thus, the problem of rapid off-track erase (ROT) may be efficiently addressed. In embodiments of the inventive concept, the disturbance sensor 460 is not limited to the RV sensor or the shock sensor. When the disturbance sensor 460 is another sensor that may sense a disturbance, discontinuance of the writing operation may be determined.

Hereinafter, operation of the disk drive 550 is described with reference to FIGS. 5B and 6C. First, an example in which the disturbance sensor 460 included in the disk driver 550 is an RV sensor is described.

When the disturbance sensor 460 is an RV sensor, it senses a disturbance at first time t1 during a writing operation for an n^{th} servo sector STn, and outputs the output value SEN. The ADC 560 may begin to convert the output value SEN into the digital sensing value DSEN at the first time t1. For convenience of description, the time between when the disturbance sensor 460 begins to output the output value SEN and when the ADC 560 begins to convert the output value SEN into the digital sensing value DSEN is ignored. The digital sensing value DSEN is obtained upon completion of converting the output value SEN by the ADC 560, and may be output as the sensing value DSEN, at second time t2 during a writing operation for the n+1^{th} servo sector STn+1.

The comparator 570 compares the sensing value DSEN with the reference value REF at a predetermined time point after the second time t2 and may generate the control signal CON for determining discontinuance of the writing operation, according to the comparison. For example, when an absolute value of the sensing value SEN is compared with the reference value REF and the absolute value is greater than the reference value REF, the comparator 570 may generate a control signal CON that discontinues the writing operation. When the absolute value is less than the reference value REF, the comparator 570 may generate a control signal CON that continues the writing operation.

The operations described in relation to the first time t1 and the second time t2 may be performed for remaining servo sectors. In FIG. 6C, the time t1 may be the latest point in time point in a section where the writing operation for the n^{th} servo sector STn is performed. As described above, the output value of the disturbance sensor 460, which is not generally used to detect ROT, is compared with the reference value REF in FIGS. 5B and 6C and discontinuance of the writing operation is determined. Thus, the problem of ROT may be efficiently addressed. The disturbance sensor 460 and the controller 430 described above may be operated in a section where one VCM interrupt service routine is performed.

Hereinafter, operation of the disk drive 500 is described with reference to FIGS. 5A and 6D. First, an example in which the disturbance sensor 460 included in the disk driver 500 is a shock sensor is described.

When the disturbance sensor 460 is a shock sensor, it senses a disturbance at first time t1 during a writing operation for an n^{th} servo sector STn, and outputs the first output value SEN1. The ADC 510 may begin to convert the first output value SEN1 into the digital first sensing value DSEN1 at the first time t1. For convenience of description, time between when the disturbance sensor 460 begins to output the first output value SEN1 and when the ADC 510 begins to convert the first output value SEN1 into the first digital value DSEN1 is ignored. The digital first sensing value DSEN1 is obtained upon completion of converting the first output value SEN1 by the ADC 510, and may be stored in the first register 520 as the first sensing value DSEN1, at second time t2 during a writing operation for the n^{th} servo sector STn. That is, the time between the first time t1 and the second time t2 may be greater than the amount of time used to convert the first output value SEN1 in analog form into the first sensing value DSEN1 in digital form by the ADC 510.

The disturbance sensor 460 senses a disturbance at third time t3 during a writing operation for the n+1^{th} servo sector STn+1, and outputs the second output value SEN2. The ADC 510 may begin to convert the second output value SEN2 into the digital second sensing value DSEN2 at the third time t3. For convenience of description, time between when the disturbance sensor 460 begins to output the second output value SEN2 and when the ADC 510 begins to convert the second output value SEN2 into the second sensing value DSEN2 is ignored. The digital second sensing value DSEN2 is obtained upon completion of converting the second output value SEN2 by the ADC 510, and may be stored in the second register 530 as the second sensing value DSEN2, at fourth time t4 during a writing operation for the n+1^{th} servo sector STn+1. That is, the time between the third time t3 and the fourth time t4 may be greater than the amount of time used to convert the second output value SEN2 in analog form into the second sensing value DSEN2 in digital form in by ADC 510.

The comparator 540 compares the reference value REF with the difference between the first sensing value DSEN1 and the second sensing value DSEN2 a predetermined point in time after the fourth time t4, and generates the control signal CON for determining discontinuance of the writing operation.

The operations described in relation to the first time t1 through the fourth time t4 may be performed for remaining servo sectors. In FIG. 6D, the third time t3 may be the latest point in time in a section where the writing operation for the n+1^{th} servo sector STn+1 is performed. For example, when the fourth time t4 is the latest point in time in a section where the writing operation for the n+1^{th} servo sector STn+1 is performed, the third time t3 may be a point in time before the fourth time t4 by the amount of time used to convert the second output value SEN2 in analog form into the second sensing value DSEN2 in digital form by the ADC 510. Also, the first time t1 may be the latest point in time in a section where the writing operation for the n^{th} servo sector STn is performed. In addition, the first time t1 may be the latest point in time in a section where the writing operation for the n^{th} servo sector STn is performed. For example, when the second time t2 is the latest point in time in the section where the writing operation for the n^{th} servo sector STn is performed, the first time t1 may be a point in time before the second time t2 by the amount of time used to convert the second output value SEN2 in analog form into the second sensing value DSEN2 in digital form in the ADC 510.

That is, the disturbance sensor 460 in FIG. 6D is operated as in the same manner as a general shock sensor; however, discontinuance of the writing operation is determined by comparing the difference between the output values of the disturbance sensor 460 with the reference value REF. Thus, the problem of ROT may be efficiently addressed. Also, in FIG. 6D, a time interval between the first time t1 and the second time t2, a time interval between the second time t2 and the third time t3, and a time interval between the third time t3 and the fourth time t4 may be the same as each other or different from each other. In addition, the disturbance sensor 460 and the controller 430 described above may be operated in a section where one VCM interrupt service routine is performed.

The case in which the disturbance sensor 460 is the shock sensor is described above in relation to FIGS. 5A and 6D. However, when the disturbance sensor 460 is the RV sensor, the difference between the first sensing value DSEN1 and the second sensing value DSEN2 may be used to determine discontinuance of the writing operation, as described above. Thus, the problem of rapid off-track erase (ROT) may be efficiently addressed. In embodiments of the inventive concept, the disturbance sensor 460 is not limited to the RV sensor or the shock sensor. When the disturbance sensor 460 is another sensor that may sense a disturbance, discontinuance of the writing operation may be determined.

Hereinafter, operation of the disk drive 550 is described with reference to FIGS. 5B and 6D. First, an example in which the disturbance sensor 460 included in the disk driver 550 is an RV sensor is described.

When the disturbance sensor 460 is an RV sensor, it senses a disturbance at first time t1 during a writing operation for an n^{th} servo sector STn, and outputs the output value SEN. The ADC 560 may begin to convert the output value SEN into the digital sensing value DSEN at the first time t1. For convenience of description, the time between when the disturbance sensor 460 begins to output the output value SEN and when the ADC 560 begins to convert the output value SEN into the digital value DSEN is ignored. The digital sensing value DSEN is obtained upon completion of converting the output value SEN by the ADC 560, and may be output as the sensing value DSEN, at a second time t2 during a writing operation for the n^{th} servo sector STn.

The comparator 570 compares the sensing value DSEN with the reference value REF at a predetermined point in time after the second time t2, and may generate the control signal CON for determining discontinuance of the writing operation. For example, when an absolute value of the sensing value SEN is compared with the reference value REF, and the absolute value is greater the reference value REF, the comparator 570 may generate a control signal CON that discontinues the writing operation. When the absolute value is less than the reference value REF, the comparator 570 may generate a control signal CON that continues the writing operation.

The operations described in relation to the first time t1 and the second time t2 may be performed for remaining servo sectors. In FIG. 6D, the second time t2 may be the latest point in time in a section where the writing operation for the n^{th} servo sector STn is performed. For example, when the second time t2 is the latest point in time in a section where the writing operation for the n^{th} servo sector STn is performed, the first time t1 may be a point in time before the second time t2 by the amount of time used to convert the output value SEN in analog form into the sensing value DSEN in digital form in the ADC 510. As described above, the output value of the disturbance sensor 460, which is not generally used to detect ROT, is compared with the reference value REF in FIGS. 5B and 6D, and discontinuance of the writing operation is determined. Thus, the problem of ROT may be efficiently addressed. The disturbance sensor 460 and the controller 430 described above may be operated in a section where one VCM interrupt service routine is performed.

Hereinafter, operation of the disk drive 500 is described with reference to FIGS. 5A and 6E. First, an example in which the disturbance sensor 460 included in the disk driver 500 is a shock sensor is described.

When the disturbance sensor 460 is a shock sensor, it senses a disturbance at first time t1 during a writing operation for an n^{th} servo sector STn, and outputs the first output value SEN1. The ADC 510 may begin to convert the first output value SEN1 into the digital first sensing value DSEN1 at the first time t1. For convenience of description, time between when the disturbance sensor 460 begins to output the first output value SEN1 and when the ADC 510 begins to convert the first output value SEN1 into the first sensing value DSEN1, is ignored. The first digital sensing value DSEN1 is obtained upon completion of converting the first output value SEN1 by the ADC 510, and may be stored in the first register 520 as the first sensing value DSEN1, at second time t2 during a writing operation for the n^{th} servo sector STn. That is, the time between the first time t1 and the second time t2 may be greater than time consumed to convert the first output value SEN1 in analog form into the first sensing value DSEN1 in digital form in the ADC 510.

The disturbance sensor 460 senses a disturbance at a third time t3 during a writing operation for the n^{th} servo sector STn and outputs the second output value SEN2. The ADC 510 may begin to convert the second output value SEN2 into the digital second sensing value DSEN2 at the third time t3. For convenience of description, time between when the disturbance sensor 460 begins to output the second output value SEN2 and when the ADC 510 begins to convert the second output value SEN2 into the second digital value DSEN2 is ignored. The digital second sensing value DSEN2 is obtained upon completion of converting the second output value SEN2 by the ADC 510, and may be stored in the second register 530 as the second sensing value DSEN2, at fourth time t4 during a writing operation for the n^{th} servo sector STn. That is, the time between the third time t3 and the fourth time t4 may be greater than the time used to convert the second output value SEN2 in analog form into the second sensing value DSEN2 in digital form by the ADC 510.

The comparator 540 compares the difference between the first sensing value DSEN1 and the second sensing value DSEN2 with the reference value REF at a predetermined point in time after the fourth time t4, and may generate the control signal CON for determining discontinuance of the writing operation, according to the comparison.

The operations described in relation to the first time t1 through the fourth time t4 may be performed for remaining servo sectors. For example, the operations in the first through fourth times t1 through t4 may be performed in fifth through eighth time t5 through t8 in relation to the n+1^{th} servo sector STn+1.

In FIG. 6E, the third time t3 may be the latest point in time in a section where the writing operation for the n^{th} servo sector STn is performed. For example, when the fourth time t4 is the latest point in time in a section where the writing operation for the n+1^{th} servo sector STn+1 is performed, the third time t3 may be a point in time occurring before the fourth time t4 by the amount of time consumed to convert the second output value SEN2 in analog form into the second sensing value DSEN2 in digital form by the ADC 510. Also, the second time t2 may be the latest point in time from among points in time before the third time t3. In addition, the first time t1 may be a point in time before the second time t2 by the amount of time used to convert the first output value SEN2 in analog form into the first sensing value DSEN1 in digital form by the ADC 510. In FIG. 6D, a time interval between the first time t1 and the second time t2, a time interval between the second time t2 and the third time t3, and a time interval between the third time t3 and the fourth time t4 may be the same as each other or different from each other. In addition, the disturbance sensor 460 and the controller 430 described above may be operated in a section where one VCM interrupt service routine is performed.

The case where the disturbance sensor 460 is the shock sensor is described above in relation to FIGS. 5A and 6E. However, when the disturbance sensor 460 is the RV sensor, the difference between the first sensing value DSEN1 and the second sensing value DSEN2 may be used to determine discontinuance of the writing operation, as described above. Thus, the problem of rapid off-track erase (ROT) may be efficiently addressed. In embodiments of the inventive concept, the disturbance sensor 460 is not limited to the RV sensor or the shock sensor. When the disturbance sensor 460 is another sensor that may sense a disturbance, discontinuance of the writing operation may be determined.

FIG. 7 is a flowchart illustrating a method of writing to a disk using the disk drive 500 of FIG. 5A, according to an embodiment of the inventive concept.

Referring to FIGS. 5A and 7, the controller 430 determines the first sensing value DSEN1 using the first output value SEN1 output from the disturbance sensor 460 during a writing operation for a plurality of servo sectors, in operation S710. Then, the controller 430 determines the second sensing value DSEN2 using the second output value SEN2 output from the disturbance sensor 460 during the writing operation for the plurality of servo sectors, in operation S720. The controller 430 then controls discontinuance of the writing operation using the difference between the first sensing value DSEN1 and the second sensing value DSEN2, in operation S730. The disturbance sensor 460 may be an RV sensor or a shock sensor, for example.

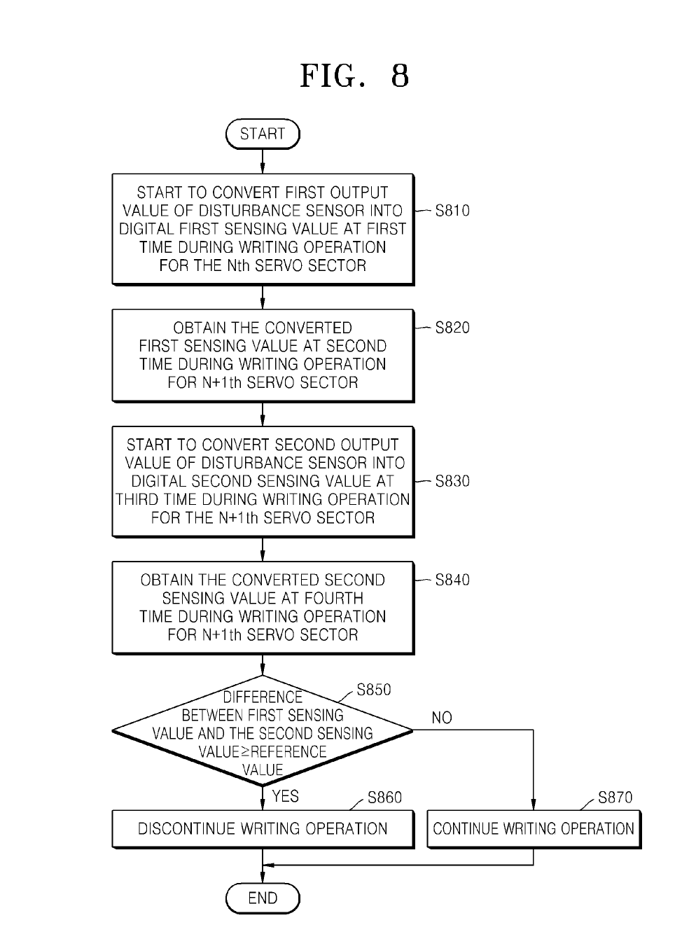

The method of writing the disk drive 500 of FIG. 5A illustrated in FIG. 7 is described more fully with reference to FIGS. 8 through 10.

FIG. 8 is a flowchart illustrating the method of FIG. 7, according to an embodiment of the inventive concept.

Referring to FIGS. 5A, 6A, 6B, 6D, and 7, the ADC 510 begins to convert the first output value SEN1 of the disturbance sensor 460 into the digital first sensing value DSEN1 at the first time t1 during the writing operation for the n^{th} servo sector STn, in operation S810. The first digital sensing value DSEN1 is obtained upon completion of converting the first output value SEN1 by the ADC 510, and may be stored in the first register 520 as the first sensing value DSEN1, at the second time t2 during the writing operation for the n+1^{th} servo sector STn+1, in operation S820. The ADC 510 begins to convert the second output value SEN2 of the disturbance sensor 460 into the digital second sensing value DSEN2 at the third time t3 after the second time t2 during the writing operation for the n+1^{th} servo sector STn+1, in operation S830. The digital second sensing value DSEN2 is obtained upon completion of converting the second output value SEN2 by the ADC 510, and may be stored in the second register 530 as the second sensing value DSEN2, at the fourth time t4 after the third time t3 during the writing operation for the n+1^{th} servo sector STn+1, in operation S840.

The comparator 540 compares the difference between the first sensing value DSEN1 and the second sensing value DSEN2 with the reference value REF, in operation S850. For example, when an absolute value of the difference between the first sensing value DSEN1 and the second sensing value DSEN2 is greater than or equal to the reference value REF, the writing operation may be discontinued in response to the control signal CON output from the comparator 540, in operation S860. As a result of the comparison in operation S850, when the absolute value of the difference between the first sensing value DSEN1 and the second sensing value DSEN2 is less than the reference value REF, the writing operation is continued in response to the control signal CON output from the comparator 540, in operation S870. When the writing operation is discontinued, in operation S860, operations S810 through S850 are again performed while a writing operation for a servo sector before the n+1^{th} servo sector STn+1 by a predetermined number is again performed. Thus, the writing operation may be again discontinued in operation S860, or continued in operation S870. Operations S810 through S870 may be performed for each servo sector until writing operations for all servo sectors are completed.

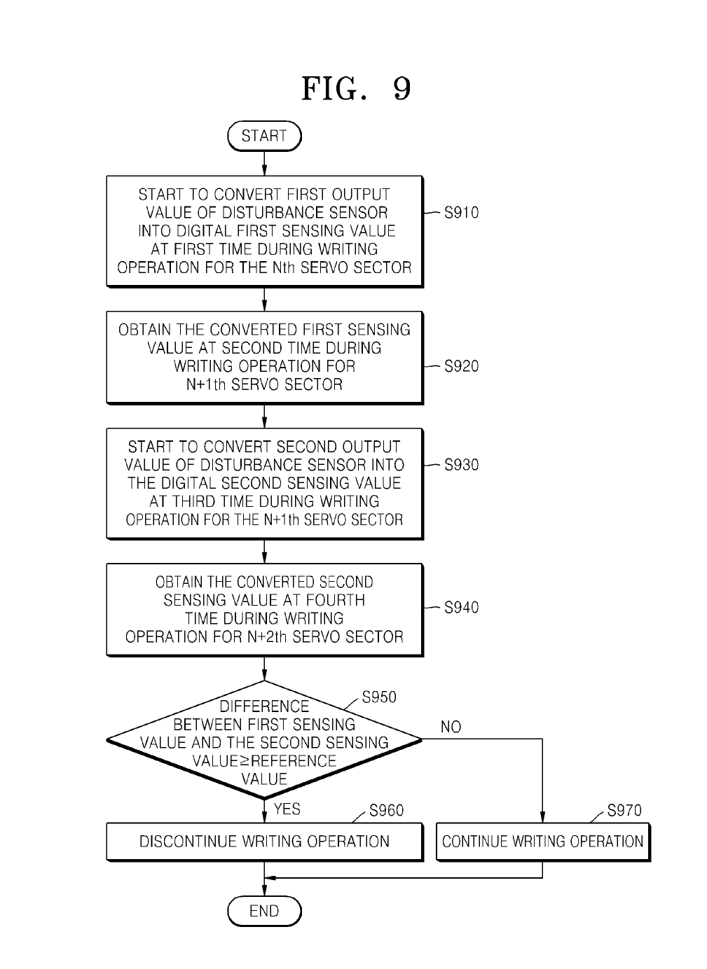

FIG. 9 is a flowchart illustrating the method of FIG. 7, according to another embodiment of the inventive concept.

Referring to FIGS. 5A, 6C, and 9, the ADC 510 begins to convert the first output value SEN1 into the digital first sensing value DSEN1 at the first time t1 during the writing operation for the n^{th} servo sector STn, in operation S910. The digital first sensing value DSEN1 is obtained upon completion of converting the first output value SEN1 by the ADC 510, and may be stored in the first register 520 as the first sensing value DSEN1, at the second time t2 during the writing operation for the n+1^{th} servo sector STn+1, in operation S920. The ADC 510 begins to convert the second output value SEN2 of the disturbance sensor 460 into the second digital sensing value DSEN2 at the third time t3 after the second time t2 during the writing operation for the n+1^{th} servo sector STn+1, in operation S930. The digital second sensing value DSEN2 is obtained upon completion of converting the second output value SEN2 by the ADC 510, and may be stored in the second register 530 as the second sensing value DSEN2, at the fourth time t4 during the writing operation for the n+2^{th} servo sector STn+2, in operation S940. The comparator 540 compares the difference between the first sensing value DSEN1 and the second sensing value DSEN2 with the reference value REF, in operation S950. For example, as a result of the comparison in operation S950, when an absolute value of the difference between the first sensing value DSEN1 and the second sensing value DSEN2 is greater than or equal to the reference value REF, the writing operation is discontinued in response to the control signal CON output from the comparator 540, in operation S960. As a result of comparison in operation S950, when the absolute value of the difference between the first sensing value DSEN1 and the second sensing value DSEN2 is less than the reference value REF, the writing operation is continued in response to the control signal CON output from the comparator 540, in operation S970. When the writing operation is discontinued in operation S960, operations S910 through S950 are again performed while a writing operation for a servo sector before the n+1^{th} servo sector STn+1 by a predetermined number is again performed. Thus, the writing operation may be again discontinued in operation S960, or continued in operation S970. Operations S910 through S970 may be performed for each servo sector until writing operations for all servo sectors are completed.

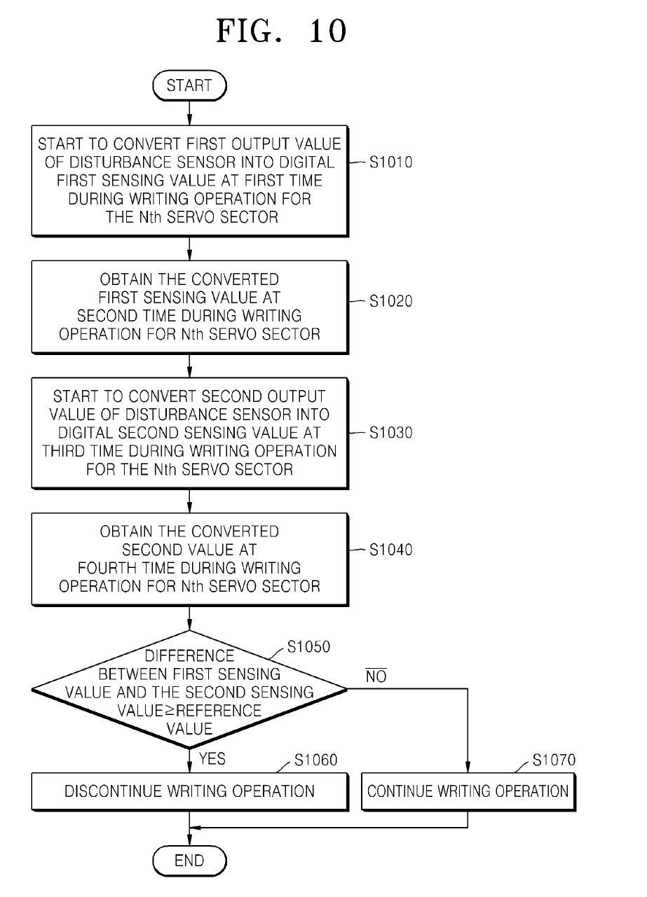

FIG. 10 is a flowchart illustrating the method of FIG. 7, according to another embodiment of the inventive concept.

Referring to FIGS. 5A, 6E, and 10, the ADC 510 begins to convert the first output value SEN1 of the disturbance sensor 460 into the digital first sensing value DSEN1 at the first time t1 during the writing operation for the n^{th} servo sector STn, in operation S1010. The digital first sensing value DSEN1 is obtained upon completion of converting the first output value SEN1 by the ADC 510, and may be stored in the first register 520 as the first sensing value DSEN1, at the second time t2 after the first time t1 during the writing operation for the n^{th} servo sector STn, in operation S1020. The ADC 510 begins to convert the second output value SEN2 of the disturbance sensor 460 into the digital second sensing value DSEN2 at the third time t3 after the second time t2 during the writing operation for the n^{th} servo sector STn, in operation S1030. The digital second sensing value DSEN2 is obtained upon completion of converting the second output value SEN2 by the ADC 510, and may be stored in the second register 530 as the second sensing value DSEN2, at the fourth time t4 after the third time t3 during the writing operation for the n^{th} servo sector STn, in operation S1040.

The comparator 540 compares the difference between the first sensing value DSEN1 and the second sensing value DSEN2 with the reference value REF, in operation S1050. For example, as a result of comparison in operation S1050, when an absolute value of the difference between the first sensing value DSEN1 and the second sensing value DSEN2 is greater than or equal to the reference value REF, the writing operation is discontinued in response to the control signal CON output from the comparator 540, in operation S1060. As a result of comparison in operation S1050, when the absolute value of the difference between the first sensing value DSEN1 and the second sensing value DSEN2 is less than the reference value REF, the writing operation is continued in response to the control signal CON output from the comparator 540, in operation S1070. When the writing operation is discontinued in operation S1060, operations S1010 through S1050 are again performed while a writing operation for a servo sector before the n^{th} servo sector STn by a predetermined number is again performed. Thus, the writing operation may be again discontinued in operation S1060, or continued in operation S1070. Operations S1010 through S1070 may be performed for each servo sector until writing operations for all servo sectors are completed.

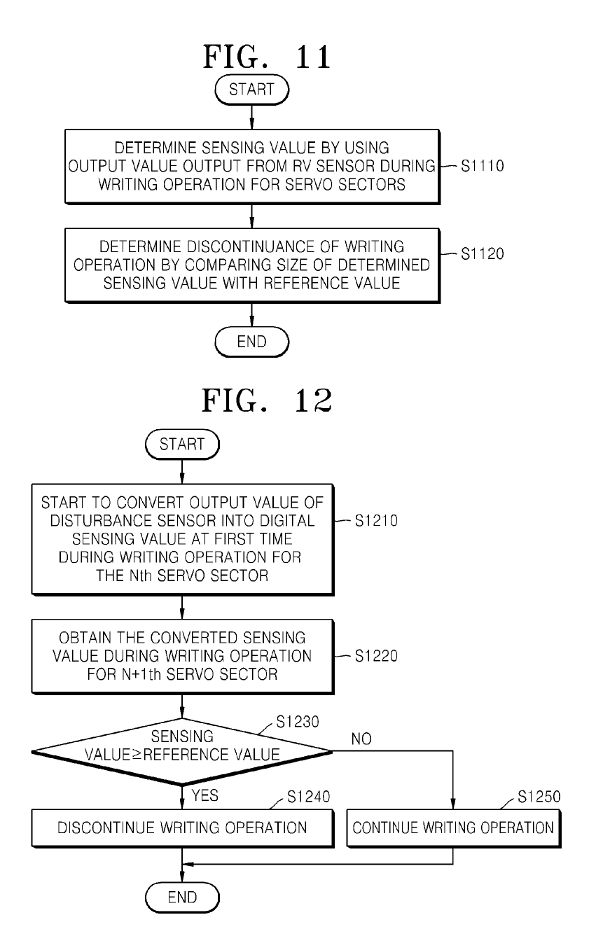

FIG. 11 is a flowchart illustrating a method of writing to a disk using the disk drive 550 of FIG. 5B, according to an embodiment of the inventive concept.

Referring to FIGS. 5B and 11, the controller 430 may determine the sensing value DSEN using the output value SEN output from the disturbance sensor 460 during a writing operation for one servo sector from among a plurality of servo sectors, in operation S1110. The controller 430 controls discontinuance of the writing operation by comparing a size of the determined sensing value DSEN with the reference value REF, in operation S1120.

As discussed above, the disturbance sensor 460 may be an RV sensor or a shock sensor, for example. When the writing operation is discontinued in operation S1120, operations S1110 through S1120 are again performed while a writing operation for a servo sector before the servo sector by a predetermined number is again performed. Thus, the writing operation may be again discontinued or continued. Operations S1110 through S1120 may be performed for each servo sector until writing operations for all servo sectors are completed.

FIG. 12 is a flowchart illustrating the method of FIG. 11, according to an embodiment of the inventive concept.

Referring to FIGS. 5B, 6C, 6D, and 12, the ADC 560 begins to convert the output value SEN of the disturbance sensor 460 into the digital sensing value DSEN at the first time t1 during the writing operation for the n^{th} servo sector STn, in operation S1210. The disturbance sensor 460 may be an RV sensor or a shock sensor, for example. In FIG. 6C, for example, the digital sensing value DSEN is obtained upon completion of converting the output value SEN by the ADC 560, and may be provided as the sensing value DSEN, at the second time t2 during the writing operation for the n+1^{th} servo sector STn+1, in operation S1220. In FIG. 6D, for example, the sensing value DSEN is obtained upon completion of converting the output value SEN by the ADC 560, and may be provided as the sensing value DSEN, at the second time t2 during the writing operation for the n^{th} servo sector STn, in operation S1220.

The comparator 570 compares the sensing value DSEN with the reference value REF, in operation S1230. As a result of comparison in operation S1130, when an absolute value of the sensing value DSEN is greater than or equal to the reference value REF, the writing operation is discontinued in response to the control signal CON output from the comparator 570, in operation S1240. As a result of comparison in operation S1130, when the absolute value of the sensing value DSEN is less than the reference value REF, the writing operation is continued in response to the control signal CON output from the comparator 570, in operation S1250. When the writing operation is discontinued in operation S1240, operations S1210 through S1230 are again performed while a writing operation for a servo sector before the n^{th} servo sector STn by a predetermined number is again performed. Thus, the writing operations may be again discontinued in operation S1140, or continued in operation S1250. Operations S1210 through S1250 may be performed for each servo sector until writing operations for all servo sectors are completed.

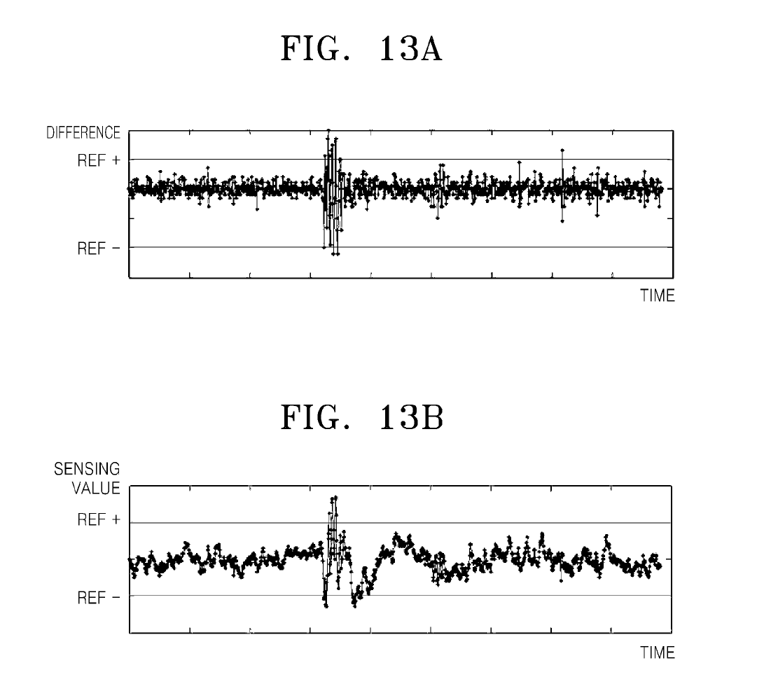

FIG. 13A is a graph illustrating differences according to the embodiments of FIGS. 5A and 7 through 10.

Referring to FIGS. 5A, 7 through 10, and 13A, a writing operation is discontinued in sections where the absolute value of the difference between the first sensing value DSEN1 and the second sensing value DSEN2 is greater than or equal to the reference value REF, which includes a section where the difference is above REF+ and a section where the difference is below REF−. Also, a writing operation is continued in a section where the absolute value of the difference between the first sensing value DSEN1 and the second sensing value DSEN2 is less than the reference value REF, which includes a section where the difference is below REF+ and a section where the difference is above REF−.

FIG. 13B is a graph illustrating sensing values according to the embodiments of FIGS. 5B, 11, and 12.

Referring to FIGS. 5B, 11, and 12, a writing operation is discontinued in a section where the absolute value of the sensing value DSEN is greater than or equal to the reference value REF, which includes a section where the sensing value DSEN is above REF+ and a section where the sensing value DSEN is below REF−. Also, a writing operation is continued in a section where the sensing value DSEN is less than the reference value REF, which includes a section where the sensing value DSEN is below REF+ and a section where the sensing value DSEN is above REF−.

While the inventive concept has been described with reference to exemplary embodiments, it will be apparent to those skilled in the art that various changes and modifications may be made without departing from the spirit and scope of the present invention. Therefore, it should be understood that the above embodiments are not limiting, but illustrative.

What is claimed is:

1. A method of writing to a disk using a disk drive, the method comprising:
determining a first sensing value using a first output value output from a disturbance sensor during a writing operation for a plurality of servo sectors on the disk;
determining a second sensing value using a second output value output from the disturbance sensor during the writing operation for the plurality of servo sectors; and
determining discontinuance of the writing operation based on the difference between the first sensing value and the second sensing value.

2. The method of claim 1, wherein the first sensing value is determined at a first point of an n^{th} (n is a natural number) servo sector of the plurality of servo sectors using the first output value, and wherein the second sensing value is determined at a second point of the n^{th} servo sector using the second output value.

3. The method of claim 1, wherein determining the first sensing value comprises:
beginning to convert the first output value into a digital first sensing value at a first time during a writing operation for an n^{th} (n is a natural number) servo sector of the plurality of servo sectors; and
obtaining the converted first sensing value at a second time during a writing operation for an n+1^{th} servo sector of the plurality of servo sectors, and
wherein determining the second sensing value comprises:
beginning to convert the second output value into a digital second sensing value at a third time after the second time during the writing operation for the n+1^{th} servo sector; and
obtaining the converted second sensing value at a fourth time during the writing operation for the n+1^{th} servo sector.

4. The method of claim 3, wherein the fourth time is a latest point in time in a section, where the writing operation for the n+1^{th} servo sector is performed, and the third time is a point in time occurring before the fourth time by an amount of time used to convert the second output value into the second sensing value.

5. The method of claim 3, wherein a time interval between the first time and the second time, a time interval between the second time and the third time, and a time interval between the third time and the fourth time are the same.

6. The method of claim 1, wherein determining the first sensing value comprises:
beginning to convert the first output value into a digital first sensing value at a first time during a writing operation for an n^{th} (n is a natural number) servo sector of the plurality of servo sectors; and
obtaining the converted first sensing value at a second time during a writing operation for an n+1^{th} servo sector of the plurality of servo sectors, and
wherein determining the second sensing value comprises:
beginning to convert the second output value into a digital second sensing value at a third time after the second time during the writing operation for an n+1^{th} servo sector; and
obtaining the converted second sensing value at a fourth time during a writing operation for the n+2^{th} servo sector of the plurality of servo sectors.

7. The method of claim 1, wherein determining the first sensing value comprises:
beginning to convert the first output value into a digital first sensing value at a first time during a writing operation for an n^{th} (n is a natural number) servo sector of the plurality of servo sectors; and
obtaining the converted first sensing value at a second time after the first time during the writing operation for the n^{th} servo sector,
wherein determining the second sensing value comprises:
beginning to convert the second output value into a digital second sensing value at a third time after the second time during the writing operation for the n^{th} servo sector; and
obtaining the converted second sensing value at a fourth time after the third time during the writing operation for the n^{th} servo sector.

8. The method of claim 1, wherein the disturbance sensor is one of a rotary vibration (RV) sensor or a shock sensor.

9. The method of claim 1, wherein determining the first sensing value and the second sensing value is performed in a section in which one VCM interrupt service routine is performed.

10. The method of claim 1, wherein determining the discontinuance of the writing operation comprises:
comparing an absolute value of the difference between the first sensing value and the second sensing value with a reference value;
when the absolute value is above the reference value, discontinuing the writing operation; and
when the absolute value is below the reference value, continuing the writing operation.

11. A method of writing to a disk using a disk drive, the method comprising:
determining a sensing value using an output value output by a rotary vibration (RV) sensor during writing operations for a plurality of servo sectors; and
determining discontinuance of the writing operation by comparing a size of the determined sensing value with a reference value.

12. The method of claim 11, wherein determining the sensing value comprises:
beginning to convert the output value into a digital sensing value at a first time during a writing operation for an n^{th} (n is a natural number) servo sector of the plurality of servo sectors; and
obtaining the converted sensing value at a second time during a writing operation for an n+1^{th} servo sector of the plurality of servo sectors.

13. The method of claim 12, wherein determining discontinuance of the writing operation comprises:
comparing an absolute value of the sensing value with the reference value;
when the absolute value is above the reference value, discontinuing the writing operation; and
when the absolute value is below the reference value, continuing the writing operation.

14. A disk drive, comprising:
a disturbance sensor configured to sense disturbances during a writing operation for a plurality of servo sectors on a disk; and
a controller configured to determine a first sensing value using a first output value provided by the disturbance sensor during the writing operation, to determine a second sensing value using a second output value provided by the disturbance sensor during the writing operation, and to determine discontinuance of the writing operation based on the difference between the first sensing value and the second sensing value.

15. The disk drive of claim 14, wherein the disturbance sensor comprises a rotary vibration (RV) sensor.

16. The disk drive of claim 14, wherein the disturbance sensor comprises a shock sensor.

17. The disk drive of claim 14, wherein the controller determines the discontinuance of the writing operation by comparing an absolute value of the difference between the first sensing value and the second sensing value with a reference value, and discontinuing the writing operation when the absolute value is above the reference value.
